(19) United States
(12) Patent Application Publication
(10) Pub. No.: US 2009/0174855 A1
(43) Pub. Date: Jul. 9, 2009

(54) SELF-DEVELOPED MICRO-RELIEF SUBSTRATE FOR UNIFORM CELL GAP

(75) Inventors: Mark Andrews, Westmount (CA); Xiangtong Li, Fremont (CA)

Correspondence Address: FULBRIGHT & JAWORSKI L.L.P., 600 CONGRESS AVE., SUITE 2400, AUSTIN, TX, 78701, US

(73) Assignee: Plastic Knowledge Inc., Montreal (CA)

(21) Appl. No.: 12/175,979

(22) Filed: Jul. 18, 2008

Related U.S. Application Data
(60) Provisional application No. 60/950,489, filed on Jul. 18, 2007.

(51) Int. Cl. G02F 1/1339

(52) U.S. Cl. 349/153; 349/155; 349/190

(57) ABSTRACT

A liquid crystal cell comprising integral microstructure spacing elements is described. Moreover, fabrication processes for forming such a liquid crystal cell are also described.

### CROSS REFERENCE TO RELATED APPLICATIONS

The present application claims the benefit of U.S. Provisional Application No. 60/950,489 filed Jul. 18, 2007, the entire contents of which are incorporated by reference.

### FIELD

The present disclosure generally relates to a process for the assembly of liquid crystal cells and to liquid crystal cells so assembled. More specifically, but not exclusively, the present disclosure relates to a process for the assembly of liquid crystal cells comprising a thin, uniform cell gap and to such liquid crystal cells.

### BACKGROUND

Liquid crystal display (LCD) devices are widely used in applications including telephones, personal digital assistants, televisions, electronic signage, and consumer electronic devices for games and music. LCDs are useful in applications where light weight, low power and a flat panel display (FPD) are desired. Typically, LC FPDs include a pair of glass substrate sheet elements which, when sealed together with a liquid crystal medium, form a cell. A cell is typically assembled following a series of steps such as described for example in “Liquid Crystal Flat Panel Displays—Manufacturing, Science & Technology” (ISBN 0-442-01428-7).

The liquid crystal material for use between the substrate sheet elements is typically selected from families of liquid crystal materials well known in the art. These materials are useful in devices that may be distinguished as twisted nematic (TN), super twisted nematic (STN), in-plane switching (IPS) as well as other liquid crystal display devices. The main steps for assembling an active matrix display typically include: (1) cleaning the substrate(s); (2) applying and surface treating the liquid crystal orientation film (generally called the alignment layer); (3) positioning the spacers; (4) applying the seal; (5) laminating and sealing the top and bottom substrates; (6) dicing the cells (multiple cells are on a wafer or panel); (7) injecting the liquid crystal; and (8) sealing the injection hole.

In general, the interior surface of the substrates is divided-up into specific regions called pixels. In active matrix LCDs (AMLCD), such pixels typically comprise transistors and transparent electrodes allowing for the application of an electric field at various points on the substrates. Changes in the electric field are typically used to cause changes in the light transmission properties of the liquid crystal device when it is mounted between a pair of polarizers in a desired optical arrangement. By patterning and segregating the transistors and the electrodes into an array of pixels, addressable pixel areas (called the active matrix on the display) are generated.

A precise gap must be maintained between the top and bottom surfaces of the active matrix display. This is typically accomplished prior to lamination by the deposition of spacers on one substrate. Spacers may comprise fibers or spheres of a uniform dimension, made either from glass, plastic or materials having hybridized properties. The spacers are typically applied by air dispersement. Typical large area flat panel displays have a cell gap ranging from at least 1 μm to several tens of micrometers, depending on the application.

A precise control over the liquid crystal material containing cell gap must be maintained. A uniform cell gap is required in order to produce a uniform electric field at low voltages as well as for obtaining a uniform contrast across the entire display area. For STN displays the cell gap usually does not exceed 5 μm, the gap tolerance being ±100 nm or less. With surface stabilized ferroelectric liquid crystal displays, a cell gap spacing of about 2 μm is generally controlled to within 0.1 μm for good performance. The requirement for a constant and uniform cell gap requires that the spacers be both of uniform size and be positioned on the substrate with high reproducibility prior to sealing. Deviations in cell gap uniformity generally lead to a reduction in the brightness and contrast of the LCD. Moreover, deviations in cell gap uniformity will generally lead to variations in field strength at the various pixels, even with the pixels being provided with the same input power. This is particularly apparent in applications in which a solid image (with equal voltages being applied at all of the pixels) is displayed across the entire LCD. If the LCD has a non-uniform cell gap, the perceived image will generally have darker and/or lighter spots or regions depending on the field strength.

Some LCD applications require a high degree of resolution. Because of the fringing field effect between the pixels, the resolution of the LCD depends, among other things, on the electric field within the liquid crystal. In high resolution applications, the fringing field will decrease the resolution of a display where the pixels are spaced at distances of less than 1 μm. By decreasing the cell gap, the LCD may show a reduction in field interference between neighboring pixels, allowing for the pixels to be more closely spaced. This closer spacing of the pixels produces a higher resolution image on the LCD.

Plastic substrate sheet elements are currently being investigated as substitutes for glass substrates in applications requiring mobility, lightness, thinness and robustness. Various organic polymeric substrates are significantly lighter than glass while also being transparent. Such substrates take preference over glass substrates in large-area lightweight display applications. However, a common problem associated with the use of polymeric materials as substrates for liquid crystal displays is their tendency to be more flexible. The increased flexibility requires the plastic substrates to be close spaced by a dense population of spacers in order to maintain a uniform cell gap, such as required for liquid crystal devices. In order to produce a uniform electric field at low voltages, in addition to providing a uniform contrast across the entire display area, a precise control over the cell gap thickness and uniformity is generally required.

A liquid crystal display capable of automated fabrication, facilitated by the use of continuous strips of plastic film on the surface of which corresponding electrode patterns are defined has been disclosed in U.S. Pat. No. 4,501,471 issued on Feb. 26, 1985 to Culley et al. A uniform spacing is achieved by means of precisely dimensioned short-length polymeric fibers. However, the use of a fibrous material as a spacer suffers from the drawback of not being readily and uniformly positioned on a substrate such that a uniform spacing is achieved over the entire surface. Moreover, fibers may overlap with each other increasing the spacer height. Yet moreover, when the device flexes or is otherwise physically stressed, the use of such spacers may result in shifting or migration, forming areas depleted in liquid crystal material in the display cell.

An optical modulation device comprising a pair of base plates and a ferroelectric liquid crystal sandwiched there between has been disclosed in U.S. Pat. No. 4,720,173 issued on Jan. 19, 1988 to Kawasaki et al. A plurality of structural members, each having side walls, is arranged in the form of stripes on one of the pair of base plates. The spacer members may be composed of a photoresist material bonded to the substrate. However, the use of bonded structural members comprises a precise positioning on each substrate with the members being of precisely the same height. This is often difficult to achieve given the dimensions and tolerances required for effective liquid crystal displays. Moreover, spacer members having a chemical composition different from that of the substrate may suffer from differential thermal expansion resulting in fractures at the substrate/spacer interface. Such fractures could possible result in a shifting of the spacer member.

LC mechanical stability is an important feature for LCDs. Various approaches providing for mechanical stability have been previously disclosed. Such approaches include the formation of polymer walls, polymer networks and micro cavities by replica molding [H. Sato, H. Fujikake, Y. Iino, M. Kawakita, and H. Kikuchi, Flexible gray scale ferroelectric liquid crystal device containing polymer walls and networks, Jpn. J. Appl. Phys 41, 5302 (2002); H. Sato, H. Fujikake, H. Kikuchi, and T. Kurita, Bending tolerance of ferroelectric liquid crystal with polymer walls fastening plastic substrate, Jpn. J. Appl. Phys. 42, L476 (2003); Y-T Kim, J-H Hong, and S-D Lee, Fabrication of a highly bendable LCD with an elastomer substrate by using a replica-molding method, J. SID, 14/12 1091 (2006)].

A process for creating a gap between a pair of substrate sheet elements, based on a polymerization-induced phase separation (PIPS) has been disclosed by Kumar et al. [Science, vol. 283, 1903 (1999); U.S. Pat. No. 5,949,508 issued on Sep. 7, 1999]. A photo-polymerizable prepolymer (i.e. monomer) was combined by dissolution with a liquid crystal compound. Anisotropic phase separation was induced by means of ultraviolet (UV) light exposure which established a light intensity gradient perpendicular to the plane of the layer. The highest light intensity was observed as occurring at the side facing the UV light source. The rate of photo-polymerization increased with increases in the UV light intensity. Polymerization thus occurs in the regions exposed to the light source. The polymerization results in the phase separation of the liquid crystal from the polymer such that two (2) layers are produced. Liquid (i.e. liquid crystal) comprising polymer cups may thus be produced. It was theorized that polymerization-induced phase separation is caused by: (1) the increasing large molecule (i.e. polymer) fraction during the polymerization process (size induced phase separation); (2) the difference in the Flory Huggins interaction parameter between the monomer and the liquid crystal material and the polymer and the liquid crystal material; and (3) the elasticity of the polymer network. However, the process disclosed by Kumar et al. requires that the liquid crystal absorb the radiation used to induce the polymerization-induced phase separation. Moreover, the liquid crystal material as used by Kumar (i.e. a cyanobiphenyl) is not suitable for use in active matrix LCD devices.

The possibility of mechanically coupling a topcoat and a substrate has been disclosed by Penterman [Nature, vol. 417, 55 (2002)]. The mechanical coupling is achieved in two steps: (i) ultraviolet radiation having a wavelength of 400 nm was used to cause phase separation to generate 100 μm wide walls which form the sides of individual boxes (cells) containing residue of liquid crystal and pre-polymer; and (ii) ultraviolet radiation having a wavelength of 340 nm was used to generate a 10 μm thick cover of polymer that seals the boxes. Thus, when conducted in the presence of a liquid crystal material, the PIPS process produces a phase separated stratified layer comprising a polymer cup in which the liquid crystal material is contained. The cup is capped with polymer derived from the phase separated stratification process. A disadvantage of this process resides in the observation that the phase separated stratified layer produced absorbs light during the photo-polymerization process. Since the polymerization rate increases with increases in the light intensity, any attenuation of the light intensity will slow the polymerization process. In order to overcome this disadvantage, a photo-bleachable dye must be used in the stratification step which renders the process more complex. A further disadvantage of the use of a dye, as thought by the process disclosed by Penterman, resides in the possibility of the dye being present in the active layer of the device resulting in adverse effects. For example, the presence of a dye in the liquid crystal medium may cause photo-degradation. Moreover, the presence of a dye may influence the dielectric constant or the birefringence of the liquid, causing a change in the electro-optical properties of the display device. Therefore, the dye should selectively accumulate in the polymer layer. A technique for the selective accumulation of the dye in the polymer layer includes adjusting the dye polarity so that it becomes more soluble in the polymer or monomer while becoming less soluble in the liquid or liquid crystal material. A further technique involves chemically linking the dye to the monomer so that it is forced to accumulate in the produced polymer layer.

The formation of a topcoat such as thought by the Penterman process implies that it be derived from a family of monomers or pre-polymers subject to photo-polymerization. Such a requirement eliminates several families of polymeric coatings, some of which may have superior physical properties including strength, flatness and optical transparency, suitable for applications not only in liquid crystal displays, but also in emissive displays like organic light emitting diodes.

The PIPS stratification approach typically suffers from the drawback that layers like silica, or other layers that may provide a barrier to the diffusion of water, ions and other compounds that might degrade the performance of the device, are not readily applied to the stratified layer. This difficulty is further compounded in cases where plastic film polarizers and color filters, well known in the art as being important to the operation of LCDs, are to be attached to the surface of the stratified layer.

The thermomechanical properties, including the coefficient of thermal expansion, are important when manufacturing plastic or flexible liquid crystal displays. This is particularly true if the top and bottom substrate layers of the display are to be bonded together by means of a spacer layer so as to maintain a constant cell gap. Differences in the thermomechanical properties between the spacer layer and the top or bottom substrate layer may result in changes in the cell gap, or even cause the stratified layer to separate from the substrate when the composite layer structure is subjected to thermal cycling.

The fabrication of polymer spacers by means of a PIPS process typically results in the formation of polymer cups for the confinement of the liquid crystal material. The liquid is typically encapsulated within the polymeric boundaries created by the PIPS process. When the liquid is confined to a cup, such as described by Kumar et al. or by Penterman, the liquid in the cup may be compressed or the walls of the cup may distort upon bending of the display members. This may further influence the electro-optical properties of the liquid crystal material, particularly if the cup is small such as required for pixels in high resolution displays.

The present disclosure refers to a number of documents, the content of which is herein incorporated by reference in their entirety.

### SUMMARY

The present disclosure broadly relates to a process for the assembly of liquid crystal cells, the process comprising the use of a substrate sheet including spacing elements that are an integral part of the substrate sheet. In an embodiment of the present disclosure, a substrate is assembled by means of a top and bottom substrate sheet, both of which comprise integral spacing elements. Such a substrate is typically referred to as a “self-developed micro-relief substrate”. In an embodiment of the present disclosure, a substrate is assembled by means of a top and bottom substrate sheet, either of which comprises integral spacing elements. Such a substrate is typically referred to as a “self-developed micro-relief half substrate”. In an embodiment of the present disclosure, the micro-relief comprises protrusions interconnected by passages. In yet a further embodiment of the present disclosure the spacing elements comprise microstructures. The microstructure spacing elements provide for structural rigidity when assembling the liquid crystal cells.

In an embodiment, the present disclosure relates to a liquid crystal cell comprising: a pair of opposed substrates, each provided with an inner surface facing one another; and integral spacing elements disposed on at least one of the opposed substrates, the spacing elements facing and supporting the other of said opposed substrates; wherein the spacing elements are produced by anisotropic phase separation of a solution comprising a prepolymer material and a liquid crystal material.

The present disclosure also relates to a process for the assembly of liquid crystal cells, the process comprising the use of a “self-developed micro-relief substrate” or a “self-developed micro-relief half substrate”, both of which combine the function of substrate and spacer element into a single structural element.

In an embodiment, the present disclosure relates to a process for the assembly of a liquid crystal cell comprising: (i) providing first and second substrates having respective inner surfaces; superposing the first and second substrates while keeping a gap there between; (iii) introducing a solution comprising a prepolymer material and a liquid crystal material in the gap; (iv) separating the prepolymer material from the liquid crystal material by anisotropic phase separation; and (v) curing the prepolymer according to a predetermined pattern; whereby the cured prepolymer defines integral spacing elements between the superposed first and second substrates.

In a further embodiment, the present disclosure relates to a process for the assembly of a liquid crystal cell comprising: (i) providing a first substrate having an inner face; (ii) introducing a solution comprising a prepolymer material and a liquid crystal material onto the inner face of the first substrate; (iii) separating the prepolymer material from the liquid crystal material by anisotropic phase separation; (iv) curing the prepolymer according to a predetermined pattern; and (v) laminating a second substrate having an inner face onto the cured patterned prepolymer; whereby the cured prepolymer defines integral spacing elements between the laminated first and second substrates.

In an embodiment, the present disclosure relates to a substrate sheet comprising microstructure spacing elements that are produced by means of photo-induced phase separation techniques. In a further embodiment of the present disclosure, the photo-induced phase separation is performed in the absence of a dye or absorbing liquid crystal material.

In an embodiment, the present disclosure relates to liquid crystal cells comprising channels formed by means of photo-induced phase separation, the channels allowing for liquid or liquid crystal material to flow there through.

In an embodiment, the present disclosure relates to liquid crystal cells comprising channels formed by means of photo-induced anisotropic phase separation, the channels allowing for liquid or liquid crystal material to flow there through.

In an embodiment, the present disclosure relates to microfluidic devices comprising channels formed by means of anisotropic phase separation and photo-induced curing of a liquid crystal/resin solution, the channels allowing for liquid or liquid crystal material to flow there through.

In an embodiment, the present disclosure relates to LCD devices comprising at least one self-developed micro-relief substrate.

In an embodiment, the present disclosure relates to LCD devices comprising at least one self-developed micro-relief half substrate.

In yet a further embodiment, the present disclosure relates to a process for manufacturing self-developed micro-relief substrates.

In yet a further embodiment, the present disclosure relates to a process for manufacturing self-developed micro-relief half substrates.

In yet a further embodiment, the present disclosure relates to a process for the assembly of liquid crystal cells comprising a uniform cell gap.

In yet a further embodiment, the present disclosure relates to a process for the assembly of liquid crystal cells comprising a uniform cell gap, the cells further comprising barrier films, polarizers and/or color filters. The attachment of barrier films, polarizers and/or color filters to the liquid crystal cells provides for improving the image quality throughout the display panel.

The foregoing and other objects, advantages and features of the present disclosure will become more apparent upon reading of the following non restrictive description of illustrative embodiments thereof, given by way of example only with reference to the accompanying drawings, and which should not be interpreted as limiting the scope of the present disclosure.

### BRIEF DESCRIPTION OF THE DRAWINGS

In the appended drawings:

FIG. 1 (which is labeled “Prior Art”) is a schematic cross-sectional view of a twisted nematic display device known in the art.

FIG. 2 (which is labeled “Prior Art”) is a schematic top view of a series of conductive transparent electrodes positioned on a substrate in accordance with an X-Y matrix design known in the art, forming a plurality of picture elements (i.e. pixels).

FIG. 3 is a schematic cross-sectional view of a liquid crystal cell in accordance with an embodiment of the present disclosure, showing transparent top and bottom substrate sheets and micro-relief spacing channels.

FIG. 4 shows a photomicrograph obtained using a polarized light microscope of a self-developed micro-relief pattern in the “off” state in accordance with an embodiment of the present disclosure. The black grid comprises vertically aligned liquid crystal whereas the orange colored squares comprise polymerized resin.

FIG. 5 shows a photomicrograph obtained using a polarized light microscope of the self-developed micro-relief pattern of FIG. 4 in the “on” state. The black grid of vertically aligned liquid crystal has become textured and lightly colored, similar to the orange colored squares of polymerized resin.

FIG. 6 shows a photomicrograph obtained using a polarized light microscope of a magnified area of a self-developed micro-relief pattern in the “off” state in accordance with an embodiment of the present disclosure. The black grid comprises vertically aligned liquid crystal whereas the orange colored squares comprise polymerized resin.

FIG. 7 shows a photomicrograph obtained using a polarized light microscope of the magnified area of FIG. 6 turned at an angle of 45 degrees. The black grid comprises vertically aligned liquid crystal whereas the orange colored squares comprise polymerized resin.

### DETAILED DESCRIPTION

In order to provide a clear and consistent understanding of the terms used in the present specification, a number of definitions are provided below. Moreover, unless defined otherwise, all technical and scientific terms as used herein have the same meaning as commonly understood to one of ordinary skill in the art to which this invention pertains.

The use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

The term “about” is used to indicate that a value includes an inherent variation of error for the device or the method being employed to determine the value.

As used in this specification, the term “integral” refers to the absence of bonding agents or further connective means.

As used in this specification, the term “micro-relief” refers to microstructure spacing elements (e.g. protrusions) being an integral part of either or both a top or bottom substrate element and having dimensions measured in micrometers, e.g. from about 1 μm up to about several tens of micrometers. The micro-relief provides for structural rigidity when assembling top and bottom substrate elements (e.g. sheets) into a liquid crystal cell.

As used in this specification, the term “self-developing” refers to the manufacture of a micro-relief profile not requiring additional process steps including but not limited to wet or dry-etching.

The present disclosure generally relates to the use of self-developed micro-relief substrate sheets suitable for use in the manufacture of electrically addressable LCDs. The self-developed micro-relief substrate sheets are assembled into liquid crystal cells. The cells typically comprise at least one bottom substrate sheet or top substrate sheet comprising a micro-relief profile. In an embodiment of the present disclosure, the micro-relief profile is attached to the substrate sheet through an alignment layer. In a further embodiment of the present disclosure, the relief profile comprises a plurality of spacing elements consisting of protrusions selected from the group consisting of squares, rectangles, circles, hexagons, diamonds and combinations thereof. In light of the present disclosure, it is well within one of ordinary skill in the art to determine further appropriate protrusion designs without departing from the spirit, scope and nature of the present disclosure. The protrusions are an integral part of the main body of at least a bottom or top sheet of the substrate, each protrusion rising to a common level above the main body of the element (as defined by an imaginary plane) to form a support for a second substrate element. When incorporated into a display device, a thin transparent, conducting layer may be applied to the surface of the self-developed micro-relief substrate elements, allowing for the application of a voltage across selected portions of the uniformly spaced LCD cell gap. Other elements typically associated with LCDs may also be associated with the self-developed micro-relief substrates of the present disclosure. In light of the present disclosure, it is well within one of ordinary skill in the art to determine further appropriate LCD elements without departing from the spirit, scope and nature of the present disclosure.

In an embodiment of the present disclosure, the protrusion pattern is obtained by means of photo-induced polymerization following an anisotropic phase separation. The protrusions are interconnected by passages such as canals or channels. The areas defining the interconnecting passages comprise independently addressable, electrically conductive regions. In an embodiment of the present disclosure, the protrusions have a height and/or width ranging from about one micrometer to about several tens of micrometers. In light of the present disclosure, it is well within one of ordinary skill in the art to determine adequate dimensions for the protrusions without departing from the spirit, scope and nature of the present disclosure.

The self-developed micro-relief substrate sheets of the present disclosure provide for the smooth and inexpensive assembly of liquid crystal cells comprising a uniform and small cell gap. In STN and ferroelectric liquid crystal display devices a uniform reduction in the cell gap is directly related to the field strength across the liquid crystal. In LCD applications requiring a low operating voltage, the cell gap may be decreased so that the operating voltage for the LCD may be decreased while still providing a uniform field strength throughout the liquid crystal. Reduced power consumption is a significant advantage for applications involving miniature LCDs since these devices are frequently portable and battery powered. Moreover, liquid crystal cells comprising a uniform and small cell gap are useful in applications requiring stronger field strengths to provide for enhanced switching times.

In an embodiment of the present disclosure, the self-developed micro-relief substrates are assembled into cells for the manufacture of electrically addressable LCDs. In a further embodiment of the present disclosure, such self-developed micro-relief substrates are manufactured by means of photo-induced curing following phase separation techniques. Photo-induced curing following phase separation provides for the manufacture of a substrate having microstructure spacing elements (i.e. micro-relief features) that are an integral part of either a top or bottom element (e.g. sheet) of the substrate. A micro-relief composed of microstructure spacing elements precisely positioned over large areas, allows for the manufacture of large area displays with uniform appearance over the entire area.

A micro-relief composed of microstructure spacing elements provides for the following advantages: (1) the micro-relief comprising substrate can be manufactured in a highly uniform manner over large areas, thus providing high optical uniformity; (2) the integral micro-relief may be manufactured to electrically isolate adjacent conductors, thus eliminating costly and yield-reducing photolithographic process steps; and (3) the LCD manufacturing process is simplified since the presence of the integral micro-relief eliminates the need to separately apply spacer beads, fibers or photolithographed dots or stripes.

The self-developed micro-relief comprising substrates of the present disclosure are useful with nematic, ferroelectric liquid crystals as well as other liquid crystal materials requiring accurate spacing control for applications in high definition, large area, direct-view projection displays as well as other non-display imaging or optical information processing components.

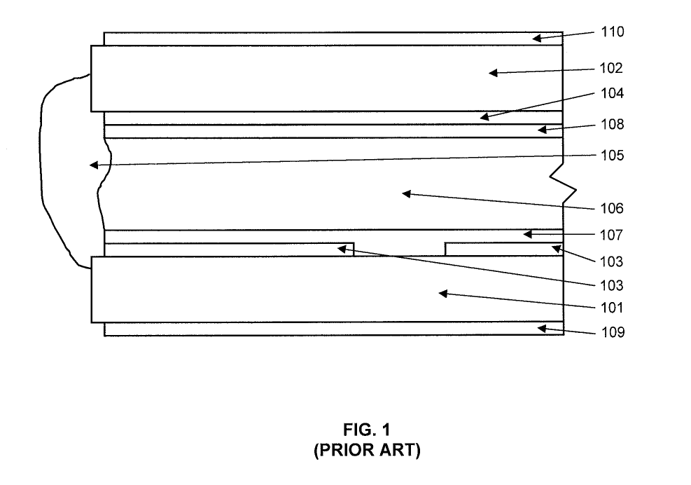

FIG. 1, which is labeled “Prior Art”, illustrates a cross-sectional view of a conventional addressable liquid crystal device of the art. More specifically, a twisted nematic display device comprising an enclosed cell or envelope 106 formed by a pair of overlying transparent planar substrates 101 and 102 is illustrated. Conductive layers 103 and 104 are deposited on the inner surface of planar substrates 101 and 102 respectively. The periphery of the transparent planar substrates 101 and 102 is joined and partially sealed with an adhesive sealant 105. The shallow space or cavity defined by cell 106 is filled with a liquid crystal material and a photo-polymerizable monomer just prior to the application of sealant 105. The conductive layers 103 and 104 may both be transparent for transmissive display applications, or only one of them may be transparent for reflective display applications. The conductive layers 103 and 104 may optionally be coated with an insulating layer (not shown) to enhance electric isolation. Alignment coatings 107 and 108 are typically applied on top of the conductive layers 103 and 104, to cause a desired orientation of the liquid crystal material at its interface with the display cell 106. The alignment coatings 107 and 108 ensure that the liquid crystal material rotates light through angles which are complementary to the alignment of the polarizers associated with the display cell 106. Alignment layers can be derived from poly(vinylalcohol) or commercial polyimides such as CP7CC3 and SEC-610, available from Nissan Chemical Company. Polarizing elements 109 and 110 may optionally be deposited on the planar substrates 101 and 102, depending on the type of display. A more exhaustive discussion of the components and assembly techniques for liquid crystal displays such as described and illustrated in FIG. 1 is provided in “Liquid Crystals-Applications and Uses”, Volume 1, Bitendra Bahadur, Ed., World Scientific Publishing Co. Pte. Ltd. (1990), Chapter 7, “Materials and Assembling Process of LCDs.”

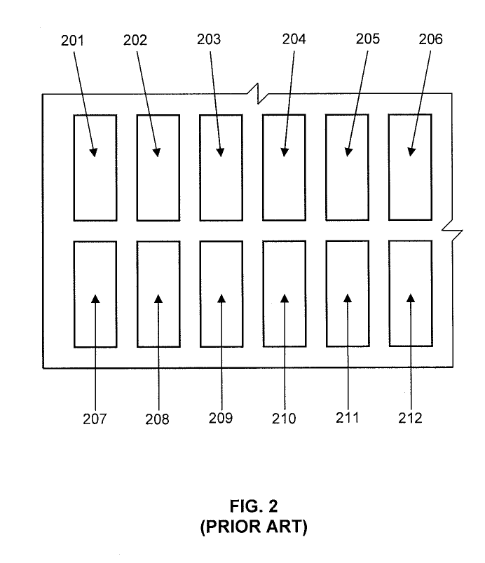

FIG. 2, which is labeled “Prior Art”, illustrates a top view of a series of conductive transparent electrodes 201-212 positioned on the inside surface of a substrate in accordance with a segmented or X-Y matrix design known in the art, forming a plurality of pixels. Although only a few electrodes are shown, a large number of electrodes are typically incorporated in the cell. The number of electrodes will generally increase as the dimensional area of the cell increases.

The self-developed micro-relief comprising substrates of the present disclosure provide for the manufacture of large area displays with uniform appearance. Large area displays typically call upon the use of one or more of the self-developed micro-relief substrate elements. To set the cell gap of the substrate, spacing elements (i.e. spacer beads) are typically dispersed between the top or bottom substrate sheet of the cell. The self-developed micro-relief then fixes the cell gap at the space set by the spacing elements. A liquid crystal cell is created by sandwiching the top and bottom substrate sheets, with the alignment layers facing one another.

Liquid crystal filling may be accomplished by any number of methods known in the art. Non-limiting examples of polar liquid crystal materials for filling may include Merck LC compositions E3, E7, E48,ZLI54-000, ZLI5400-110 and BDH compositions BL-001 through BL032. When using the one drop filling method, a mixture of liquid crystal and photosensitive prepolymer are dropped onto the alignment layer surface of one of the substrate sheets. Non-limiting examples of photosensitive prepolymer materials may be derived from Norland products NOA60, NOA61, NOA63, NOA65, NOA68, NOA71, NOA72, NOA73, NOA77, NOA81and NOA88. Cell gap control spacers (i.e. spacer beads) may optionally be mixed with the liquid crystal/prepolymer mixture or dispersed separately onto the surface of the alignment layer. Alternatively, a mixture of liquid crystal and photosensitive prepolymer material may be filled into the spacer defined cell gap following the sandwiching of the substrate sheets. This is typically accomplished by means of capillary action. Filling the cell gap may be conducted at room temperature or above the temperature of the isotropic phase of the liquid crystal material.

A photomask is used to project an image onto the photo-sensitive liquid crystal/prepolymer mixture after it has undergone anisotropic phase separation by cooling of the mixture. The UV illumination associated with the photomask projection causes both a prepolymer material concentration gradient towards to UV light exposed regions and polymerization of the prepolymer material. In other words, on cooling, the isotropic system breaks symmetry and undergoes a phase transition in which the prepolymer material forms droplets in the liquid crystal phase. On further cooling, the droplets coalesce or otherwise grow by accretion of prepolymer molecules. Photoexposure through openings in the mask illuminates both the prepolymer material and the liquid crystal, but only the prepolymer material polymerizes. Polymerization causes a concentration gradient in the prepolymer material because they are depleted in concentration in the regions exposed to UV light. Therefore, there is a chemical potential, a gradient, that induces more prepolymer material to diffuse from dark regions where there is no exposure to light, to the regions where prepolymer material is being consumed by polymerization under UV light. It is well within one of ordinary skill in the art to determine adequate patterns for the photomask without departing from the spirit, scope and nature of the present disclosure. Since the anisotropic phase separation is mainly achieved by cooling the liquid crystal/prepolymer solution, there is no need for a dye material or a light absorbing liquid crystal material in the anisotropic phase separation step. Phase separation can be promoted by mixing a polar liquid crystal material (e.g. Merck LC and BDH compositions) with a non-polar resin material (e.g. prepolymer material from Norland). In this case, if a polar alignment layer is used, the polar LC material will tend to interact (“wetting”) with the polar alignment layer and the non-polar resin material will tend to segregate away from the polar surface causing the LC to be enriched in the regions of the polar alignment layer. Thus when the resin/LC composition is exposed to actinic light the phase separation may proceed more cleanly.

In a similar way, a non-polar alignment layer may be selected to interact with a polar resin and a non-polar LC material. In this case, exposure of the polar resin to a suitable light source will cause the polar resin to phase separate more cleanly from the non-polar LC material.

It should be noted that an alignment layer may not be necessary. In that case, interaction of the LC materials and resins will depend on the polarity of the substrate with which the LC and resin materials are in direct contact.

For active matrix displays, micro openings may be positioned over the active electronic driving elements such as, but not limited to, thin film transistors (TFTs).

For passive matrix displays, micro openings may be positioned over areas devoid of imaging or other optical signal processing pixels.

For other applications, the openings as positioned over areas devoid of imaging or other optical signal processing pixels may be of any size.

The liquid crystal/prepolymer mixture may generally comprise from about 5% to about 40% by weight of resin. In an embodiment, the liquid crystal/prepolymer mixture comprises a weight ratio of 85:15. As mentioned hereinabove, the anisotropic phase separation is achieved by cooling the liquid crystal/prepolymer mixture from a temperature at which both materials are miscible and isotropic. The cell gap is filled while maintaining the composition in the isotropic phase, which is typically at about 85° C. When the cell gap is filled, the liquid crystal/prepolymer mixture is allowed to slowly cool so that anisotropic phase separation occurs.

In an embodiment of the present disclosure, slow cooling is achieved using a temperature regulator such as a Mettler FIP 82HT hot stage. The phase separation that occurs with cooling causes the polar LC material to accumulate and enrich the region of the polar alignment layer. The resin material, which will separate and associate into microdroplets exhibiting poor wetting of the alignment layer, eventually becomes large enough to span and simultaneously touch the top and bottom substrate interfaces. In an embodiment of the present disclosure, the liquid crystal/prepolymer mixture is then exposed to UV light through a patterned photomask, both to align the resin droplets according to the predetermined pattern dictated by the photomask and to cure the resin.

The photomask may be positioned on top of the sandwiched liquid crystal flat panel with the mask openings directly overlying the active electronic driving elements (e.g. thin film transistors). A light source having a wavelength required to optically cure the photosensitive prepolymer materials as mixed with the liquid crystals is typically selected. The selection of such a wavelength is believed to be within the knowledge of one skilled in the art. The optical curing process may be performed at room temperature, or, alternatively, at a temperature above the isotropic phase of the liquid crystal material to enhance the phase separation between the prepolymer and the liquid crystal material. The total optical dosage may be controlled, such that complete phase separation between the liquid crystal material and the polymer is achieved. Following the photocuring step, there should only be a minimal amount of prepolymer material remaining in the liquid crystal material comprising region. The light source may be either polarized or non-polarized (i.e. random) to cause additional photo-alignment in the photocured polymer thus ensuring better liquid crystal alignment.

In an embodiment of the present disclosure, the light source is oriented through the photomask perpendicularly to the liquid crystal panel. Alternatively, an oblique incidence irradiation of the liquid crystal panel may be used to obtain a desired polymer curing function for better liquid crystal alignment.

Finally, the curing process is completed by irradiating the liquid crystal panel in the absence of the photomask. This ensures the substantially complete consumption of any remaining photosensitive prepolymer material and the formation of a performance stable panel. For most of the liquid crystal display modes, the presence of any remaining prepolymer material does not affect proper electro-optical performance.

Display modes requiring polymer stabilization may be cured using a reduced optical dosage (i.e. reduced irradiation) in order to leave an amount of prepolymer material for liquid crystal alignment purposes. This type of irradiation procedure may be combined with the bulk liquid crystal alignment treatment which typically does not require a surface alignment layer. It is well within one of ordinary skill in the art to determine further methods for achieving a patterned exposure without departing from the spirit, scope and nature of the present disclosure. Non-limiting examples of such further methods include laser interference patterning at desired wavelengths and patterns, and laser irradiation through optical gratings.

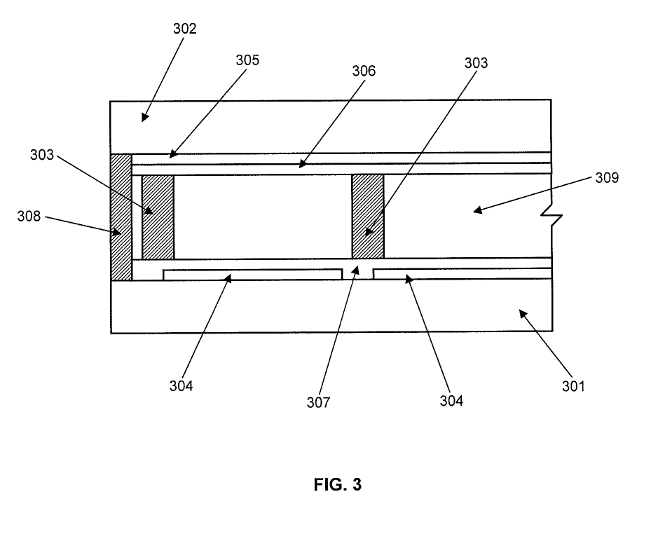

FIG. 3 is a schematic cross-sectional view of a portion of a liquid crystal cell in accordance with an illustrative embodiment of the present disclosure. The liquid crystal cell comprises transparent top and bottom substrate sheets 302 and 301 respectively. The substrate sheets are sandwiched with their alignment surfaces facing each other. Micro-relief spacing elements 303 are positioned between the top and bottom substrate sheets 302 and 301. In an embodiment of the present disclosure, and as illustrated in FIG. 3, the spacing elements 303 (i.e. relief features) are an integral part of bottom substrate sheet 301 and rise to support top substrate 302. Transparent conductive electrodes 305 and 304 are positioned on the interior surface of the top and bottom substrate sheets 302 and 301 respectively. The conductive electrodes are connected to a voltage source (not shown) to create an electric field between opposed electrodes. Optional alignment layers 306 and 307 are deposited on the inner surface of top and bottom substrate sheets 302 and 301 respectively. The top substrate sheet 302 is bound to the spacing elements 303 by means of a photo-polymerization process which optionally may also seal the periphery of the cell. The relief spacing elements 303, together with substrate sheets 301 and 302 respectively, form a cavity in which a liquid crystal material 309 is contained. The cell is finally sealed using an adhesive/sealant 308. In an embodiment of the present disclosure, the bottom substrate 301 is an optically transparent thermoplastic polymeric material capable of supporting the micro-relief spacing elements 303. Moreover, the substrate should have adequate dimensional stability for the conditions encountered during the manufacture and use of the display device. Non-limiting examples of suitable transparent thermoplastic materials include polycarbonate, polyvinyl chloride, polystyrene, polymethylmethacrylate, polyurethane, polyimide and polysulfuric polymers. It is well within one of ordinary skill in the art to determine further appropriate transparent thermoplastic materials without departing from the spirit, scope and nature of the present disclosure.

As illustrated in FIG. 3, contrary to bottom substrate sheet 301, top substrate sheet 302 does not comprise any micro-relief features. Top substrate 302 typically comprises an optically transparent thermoplastic polymeric material similar or identical to bottom substrate 301. Alternatively, top substrate 302 may be composed of glass or a glass-like material.

In an embodiment of the present disclosure, top substrate 302 also comprises micro-relief features. In embodiments wherein the top substrate also comprises micro-relief features, the substrate is typically a transparent thermoplastic polymeric material such as described for bottom substrate 301.

FIG. 3 illustrates the relief spacing elements 303 as being a series of square protrusions creating parallel channels. It is well within one of ordinary skill in the art to determine further appropriate protrusion designs without departing from the spirit, scope and nature of the present disclosure. Thus, protrusions of various geometric shapes can function as relief spacing elements without departing from the spirit, scope and nature of present disclosure. The relief spacing elements are typically generated by means of anisotropic photo-induced phase separation. The lateral distance between the relief spacing elements (i.e. protrusions) may vary, depending on the particular application for the display device. The width of the relief spacing elements can range from about 1 μm to about 100 μm or more. The upper limit is typically governed by the total inactive area that can be tolerated in a given display application. In an embodiment of the present disclosure, the lateral distance is at least 10 times the width of the spacing element. The dimensions of the relief spacing elements are typically determined by the TFT matrix designs and cover only non-display areas.

The transparent conductive electrodes are typically composed of conducting oxides such as but not limited to indium-tin-oxide (ITO). It is well within one of ordinary skill in the art to determine further appropriate conductive materials without departing from the spirit, scope and nature of the present disclosure. The conductive materials are typically vapor deposited onto the surface of the substrate by means of sputtering techniques. It is well within one of ordinary skill in the art to determine further appropriate methods for depositing the conductive material without departing from the spirit, scope and nature of the present disclosure. Vapor deposition frequently results in conductive material being deposited on the relief spacing elements. If not removed, these undesired conductive areas could possibly short across the electrode regions on the mating substrate. Various techniques can be used to remove these undesired conductive areas, non-limiting examples including burnishing the tops of the relief spacing elements following deposition and etching off the undesired conductive areas while protecting the desired electrode surface with photoresist. When the etching technique is used, a positive photoresist is typically applied to the entire substrate surface.

Following the removal of the conductive layer from the relief spacing elements, the photoresist protecting the electrode surfaces is stripped away, and the alignment coating and/or other materials are applied as desired. It is well within one of ordinary skill in the art to determine adequate alignment coatings without departing from the spirit, scope and nature of the present disclosure. Alignment coatings are typically polymeric materials applied from solvents by spin coating or other techniques well known in the art. Alignment coatings are typically, thin, uniform coatings. Once applied, the alignment layer is dried and treated to provide an orientation surface for the liquid crystal material. In an embodiment of the present disclosure, the alignment layer comprises a polyimide.

A wide variety of adhesive/sealant materials for use in the manufacture of liquid crystal cells are known in the art. Polymerizable organic materials are typically used with plastic and glass substrates. Heat curing epoxies are well known and have good strength while being relatively impervious to attack by liquid crystal materials. Light curing adhesives are also commonly used and have the advantage of eliminating the stresses induced by a heat curing process. In an embodiment of the present disclosure, the adhesive/sealant material comprises a UV curable acrylate. It is well within one of ordinary skill in the art to determine adequate adhesive/sealant materials without departing from the spirit, scope and nature of the present disclosure.

In order to achieve optical uniformity over the entire microstructure-spaced LCD, the relief structures of a first substrate sheet must remain in contact with the mating substrate so that the cell spacing is maintained throughout.

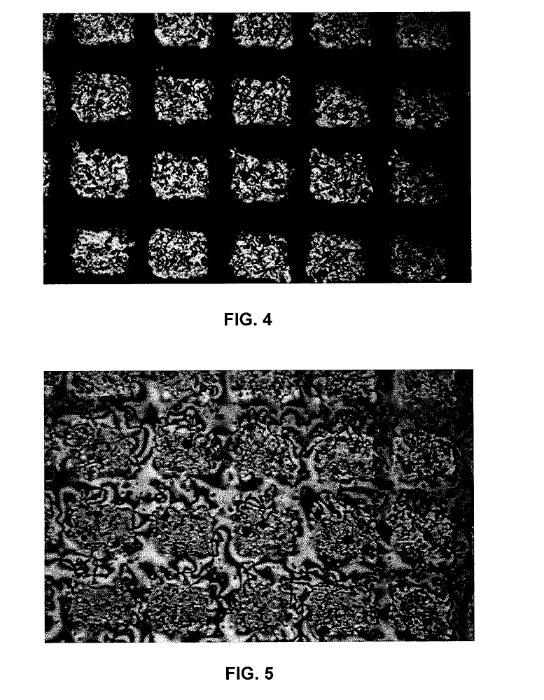

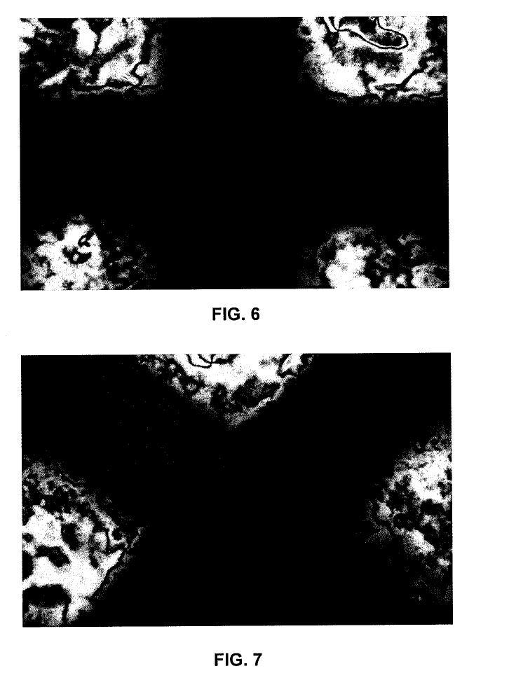

In an embodiment of the present disclosure, a cell is constructed from two sheets of plastic substrate material. The substrates are coated with a thin layer of ITO to form conductive transparent electrodes. A polyimide solution is then coated onto the bottom substrate. The alignment layer is both polar and self-aligning (i.e. it does not need to be rubbed to confer alignment properties). A LC material (e.g. MLC-6609) and resin solution (e.g. NOA72; Norland Products), were mixed in a weight ratio of 85:15. A cell gap of approximately 5 μm is achieved by dispersing 5 μm plastic beads on the surface of the bottom substrate. The LC/resin solution is then filled into the empty cell at a temperature of 85° C. At this temperature, the mixture is homogeneous and isotropic. The cell is cooled towards room temperature, and, at a temperature below 70° C., the isotropic solution as observed under a polarized light microscope, phase separates into two regions of birefringent and mainly nematic (LC rich) regions, and isotropic (resin rich) regions. With further cooling towards room temperature, the nematic regions continue to enlarge out of solution; the isotropic phase rich in resin is observed to be uniformly dispersed in the vertically aligned nematic host liquid crystal. In other words, the anisotropic phase separation of the prepolymer material and the liquid crystal material is achieved by cooling the solution. The cell is then irradiated with UV light through a photomask having a square array grid pattern. This irradiation causes the resin droplets to migrate towards the illuminated portions of the solution. The resin droplets polymerize and form solid squares in the illuminated portions of the solution. FIG. 4 shows a polarized light photomicrograph of the texture of the self-developed phase separated square array structure with no voltage applied, i.e. in the “off” state. The black grid region is rich in LC material. The light regions comprise the resin material that attaches the bottom and top substrates. Thus the resin material defines a grid of channels containing regions rich in LC material. The polymer squares do not cause disclination lines, indicating that the LC is aligned vertically and uniformly in the region of the solid polymer. FIG. 5 shows that the composition becomes transmissive when in the “on” state. The regions of the polymer squares do not show switching properties because they are isotropic and do not operate under the switching conditions. FIGS. 6 and 7 show an enlargement of a section of FIG. 4. FIGS. 6 and 7 show that the liquid crystal (black area) is free of defects, indicating that the alignment is excellent and that there is a very high level of black (opaqueness) in the regions depleted of resin.

Even though the creation of spacer elements is described hereinabove as being achieved in the cell gap separating the two substrates, it is possible to create an array of polymer islands (i.e. spacers) in the absence of a top substrate. This might be done, for example, by means of an extrusion process. A photomask would then be brought into proximity and the image of the mask projected by UV radiation into the solution. Subsequently, a top (or bottom) layer might be laminated or otherwise attached to the pre-formed patterned layer. This might be accomplished using an adhesive coating.

It is to be understood that the disclosure is not limited in its application to the details of construction and parts illustrated in the accompanying drawings and described hereinabove. The disclosure is capable of other embodiments and of being practiced in various ways. It is also to be understood that the phraseology or terminology used herein is for the purpose of description and not limitation. Hence, although the present disclosure has been provided hereinabove by way of illustrative embodiments thereof, it can be modified, without departing from the spirit, scope and nature of the disclosure as defined in the appended claims.

### REFERENCES

1. Liquid Crystal Flat Panel Displays—Manufacturing, Science & Technology” (ISBN 0-442-01428-7).
2. U.S. Pat. No. 4,501,471.
3. U.S. Pat. No. 4,720,173.
4. Sato, H.; Fujikake, H.; Iino, Y.; Kawakita, M.; Kikuchi, H. Flexible gray scale ferroelectric liquid crystal device containing polymer walls and networks, Jpn. J. Appl. Phys 41, 5302 (2002);
5. Sato, H.; Fujikake, H.; Kikuchi, H.; Kurita, T. Bending tolerance of ferroelectric liquid crystal with polymer walls fastening plastic substrate, Jpn. J. Appl. Phys. 42, L476 (2003);
6. Kim, Y-T.; Hong, J-H.; Lee, S-D. Fabrication of a highly bendable LCD with an elastomer substrate by using a replica-molding method, J. SID, 14/12 1091 (2006).
7. Kumar et al. Science, vol. 283, 1903 (1999).
8. U.S. Pat. No. 5,949,508.
9. Penterman, Nature, vol. 417, 55 (2002).
10. Liquid Crystals-Applications and Uses, Volume 1, Bitendra Bahadur, Ed., World Scientific Publishing Co. Pte. Ltd. (1990), Chapter 7, Materials and Assembling Process of LCDs.

What is claimed is:

1. A liquid crystal cell comprising:
a pair of opposed substrates, each provided with an inner surface facing one another; and
integral spacing elements disposed on at least one of the opposed substrates, the spacing elements facing and supporting the other of said opposed substrates;
wherein the spacing elements are produced by anisotropic phase separation of a solution comprising a prepolymer material and a liquid crystal material.

2. The liquid crystal cell of claim 1 further comprising control spacers disposed on one of the opposed substrates, the control spacers defining a cell gap between the pair of opposed substrates.

3. The liquid crystal cell of claim 2, wherein the control spacers are selected from the group consisting of glass beads, plastic beads and beads comprising a material having hybridized properties.

4. The liquid crystal cell of claim 2, wherein the control spacers have a thickness ranging from about 1 μm to about 20 μm.

5. The liquid crystal cell of claim 1 further comprising an electrode layer disposed on the inner surface of each substrate.

6. The liquid crystal cell of claim 5 further comprising an alignment layer disposed on the electrode layer of each substrate.

7. The liquid crystal cell of claim 1, wherein the substrates are optically transparent self-supporting layers.

8. The liquid crystal cell of claim 1, wherein the prepolymer material is selected from the group consisting of NOA60, NOA61, NOA63, NOA65, NOA68,NOA71, NOA72, NOA73, NOA77, NOA81 and NOA88.

9. The liquid crystal cell of claim 1, wherein the liquid crystal material is selected from the group consisting of E3, E7, E48, ZLI54-000, ZLI5400-110 and BL-001 through BL032.

10. The liquid crystal cell of claim 1 further comprising an adhesive sealant to seal the gap between the substrates.

11. The liquid crystal cell of claim 11, wherein the adhesive sealant is selected from the group consisting of polymerizable organic materials, heat curing epoxies, light curing adhesives and UV curable acrylates.

12. The liquid crystal cell of claim 1, wherein the solution comprising a prepolymer material and liquid crystal material are mixed in a weight ratio ranging from about 5:95 to about 35:65.

13. A process for the assembly of a liquid crystal cell comprising:
providing first and second substrates having respective inner surfaces;
superposing the first and second substrates while keeping a gap there between;
introducing a solution comprising a prepolymer material and a liquid crystal material in the gap;
separating the prepolymer material from the liquid crystal material by anisotropic phase separation; and
curing the prepolymer according to a predetermined pattern;
whereby the cured prepolymer defines integral spacing elements between the superposed first and second substrates.

14. The process of claim 13 further comprising providing control spacers between the superposed first and second substrate.

15. The process of claim 14, wherein the control spacers comprise a material selected from the group consisting of glass, plastic and materials having hybridized properties.

16. The process of claim 13, wherein the control spacers comprise a thickness ranging from about 1 μm to about 20 μm.

17. The process of claim 13 further comprising depositing an electrode layer on the inner surface of each substrate.

18. The process of claim 17 further comprising depositing an alignment layer on the electrode layer of each substrate.

19. The process of claim 13, wherein the first and second substrates are optically transparent self-supporting layers.

20. The process of claim 13, wherein the prepolymer material is selected from the group consisting of NOA60, NOA61, NOA63, NOA65, NOA68,NOA71, NOA72, NOA73, NOA77, NOA81 and NOA88.

21. The process of claim 13, wherein the liquid crystal material is selected from the group consisting of E3, E7, E48, ZLI54-000, ZLI5400-110 and BL-001 through BL032.

22. The process of claim 13 further comprising sealing the gap with an adhesive sealant.

23. The process of claim 22, wherein the gap sealing comprises sealing the gap with an adhesive sealant selected from the group consisting of polymerizable organic materials, heat curing epoxies, light curing adhesives and UV curable acrylates.

24. The process of claim 13, wherein the solution comprises a prepolymer material and liquid crystal material mixed in a weight ratio ranging from about 5:95 to about 35:65.

25. The process of claim 13, wherein the anisotropic phase separation comprises cooling the introduced solution.

26. The process of claim 13, wherein curing the prepolymer comprises projecting a photomask having the predetermined pattern onto one of the first and second substrates.

27. The process of claim 26, wherein the prepolymer curing includes projecting UV light onto one of the first and second substrates.

28. The process of claim 27, wherein the prepolymer curing further comprises irradiating in the absence of the photomask to cure prepolymer remaining in the solution.

29. A process for the assembly of a liquid crystal cell comprising:
providing a first substrate having an inner face;
introducing a solution comprising a prepolymer material and a liquid crystal material onto the inner face of the first substrate;
separating the prepolymer material from the liquid crystal material by anisotropic phase separation;
curing the prepolymer according to a predetermined pattern; and
laminating a second substrate having an inner face onto the cured patterned prepolymer;
whereby the cured prepolymer defines integral spacing elements between the laminated first and second substrates.
